(19) United States
(12) Patent Application Publication
(10) Pub. No.: US 2012/0010377 A1
(43) Pub. Date: Jan. 12, 2012

(54) Catalyst System for the Polymerization of Alpha-Olefins

(75) Inventors: Marc Oliver Kristen, Sulzbach (DE); Markus Enders, Dossenheim (DE); Stefan Mark, Blaubeuren (DE)

(73) Assignee: BASELL POLYOLEFINE GMBH, Wesseling (DE)

(21) Appl. No.: 13/202,712

(22) PCT Filed: Mar. 24, 2010
(86) PCT No.: PCT/EP2010/001843

§ 371 Date: Sep. 29, 2011

Related U.S. Application Data
(60) Provisional application No. 61/211,572, filed on Apr. 1, 2009.

(30) Foreign Application Priority Data
Mar. 30, 2009 (EP) 09004524.6

(51) Int. Cl. C08F 4/69; C08F 2/00; C08F 10/00; C08F 4/42

(52) U.S. Cl. 526/126; 502/152; 502/155; 526/134

(57) ABSTRACT

The invention refers to a catalyst system for the polymerization of olefins including a diorganohydroborane molecular weight modifier. By addition of diorganohydroborane to the catalyst system it is possible to control the molecular weight of a polyolefin to higher values.

This application is the U.S. national phase of International Application PCT/EP2010/001843, filed Mar. 24, 2010, claiming priority to European Application 09004524.6 filed Mar. 30, 2009 and the benefit under U.S.C. 119(e) of U.S. Provisional Application No. 61/211,572, filed Apr. 1, 2009; the disclosures of International Application PCT/EP2010/001843, European Application 09004524.6 and U.S. Provisional Application No. 61/211,572, each as filed, are incorporated herein by reference.

The present invention relates to a catalyst system comprising a molecular weight modifier and the use of this catalyst system in the polymerization of α-olefins for controlling the molecular weight of the produced polyolefin. The present invention further relates to a process for the preparation of polymers of α-olefins in the presence of the catalyst system.

There are several molecular weight modifiers described in the prior art which lead to a decrease of molecular weight of the produced polyolefin. EP 0 435 250 A2 e.g. discloses that dialkylzinc compounds act as molar mass regulators in the case of Ziegler catalysts. EP 1 092 730 A1 describes such an effect of dialkylzinc compounds in reducing the molecular weight and increasing the activity of the catalysts in presence of metallocene catalysts, too. Furthermore, EP 1 092 730 A1, WO 98/56835 A1 and U.S. Pat. No. 6,642,326 B1 teach that silanes having a maximum of three radicals which are different from hydrogen also act as molar mass regulators and reduce the molar mass and at the same time increase the activity of the catalysts. Substituted silanes in which at least one radical is an alkoxy or aryloxy group are known, for example from EP 447 959 A2, as cocatalysts for Ziegler-Natta catalysts.

Amin, S. B. and Marks, T. J. in Angew. Chem. 2008, 120, 2034 give a general overview about chain transfer and termination of the growing polymer chain. Among other reagents organoboranes and hydroorganoboranes are discussed which in combination with single site catalysts lead to a significant decrease of the molecular weight in olefin polymerization due to chain transfer to boron and therefore termination of the growing polymer chain.

However, hardly any reagents are known which lead to an increase of molecular weight. WO 03/104290 A2 discloses that in the case of single site catalysts comprising cyclopentadienyl ligands, appropriately substituted silanes lead to an increase in the molar mass of the polyolefins formed without the activity of the catalysts being reduced.

Since there is still a demand for controlling the molecular weights of polyolefins to higher values it is an object of the present invention to provide measures for the polymerization of α-olefins, which make it possible to control molecular weights to higher molecular weights.

We have found that this object is achieved by a catalyst system for the polymerization of α-olefins comprising a monocyclopentadiene transition metal complex and a boron compound of formula I

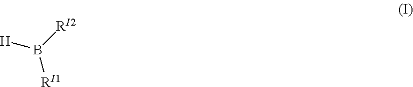

wherein
R^{I1}, R^{I2} are each C₁-C₂₀-alkyl, C₆-C₄₀-aryl, alkylaryl or arylalkyl, each having 1 to 10 carbon atoms in the alkyl radical and 6 to 20 carbon atoms in the aryl radical, or 5- to 7-membered C₁-C₂₀-cycloalkyl which in turn may carry C₁-C₁₀-alkyl as a substituent, or R^{I1} and R^{I2} together form a cyclic group of 4 to 15 carbon, the use of this catalyst system in a polymerization process of α-olefins for controlling the molecular weight of the produced polyolefin, and a process for the preparation of polymers of α-olefins in the presence of this catalyst system.

Preferred compounds of the general formula I are those in which R^{I1} and R^{I2} are each C₁-C₁₀-alkyl, in particular C₁-C₁₀-alkyl, C₆-C₁₀-aryl or 5- to 7-membered cycloalkyl, or R^{I1} and R^{I2} together form a cyclic group of 4 to 15, preferably 6 to 12, carbon atoms.

R^{I1} and R^{I2} together particularly preferably form a bicyclic group of 4 to 15, preferably 6 to 12 carbon atoms, for example bicyclohexanes, bicycloheptanes, bicyclooctanes, bicyclononanes or bicyclodecanes.

A particularly preferred compound of the general formula I is 9-borabicyclo[3.3.1]nonane (9-BBN).

Mixtures of different compounds of the general formula I may also be added. Compounds of the general formula I and processes for their preparation are known per se and are described, for example, in Encyclopedia of Inorg. Chem., ed. R. B. King, (1994), Vol. 1, page 116 et seq. and page 401 et seq.

Preferred catalyst systems comprise monocyclopentadienyl complexes comprising a substituent Y^{II} which is bound to a cyclopentadienyl system Cp^{II} and contains at least one uncharged donor containing at least one atom of group 15 or 16 of the Periodic Table

Especially useful are catalyst systems wherein the active catalyst component is selected from monocyclopentadienyl complexes having the structural feature of the formula II

Cp^{II}-Y^{II}ₘM^{II}X^{II}ₙ (II),

where the variables have the following meanings:
Cp^{II} is a cyclopentadienyl system,
Y^{II} is a substituent which is bound to Cp^{II} and contains at least one uncharged donor containing at least one atom of group 15 or 16 of the Periodic Table,
M^{II} is titanium, zirconium, hafnium, vanadium, niobium, tantalum, chromium, molybdenum or tungsten or an element of group 3 of the Periodic Table and the lanthanides;
m is 1, 2 or 3
X^{II} are ligands and
n is 1, 2 or 3.

Cp^{II} is a cyclopentadienyl system which can bear any substituents and/or be fused with one or more aromatic, aliphatic, heterocyclic or heteroaromatic rings, with 1, 2 or 3 substituents, preferably 1 substituent, being formed by the group Y^{II} and/or 1, 2 or 3 substituents, preferably 1 substituent, being substituted by the group Y^{II} and/or the aromatic, aliphatic, heterocyclic or heteroaromatic fused ring being 1, 2 or 3 substituents Y^{II}, preferably 1 substituent Y^{II}. The cyclopentadienyl skeleton itself is a C₅-ring system having 6 π-electrons, with one of the carbon atoms also being able to be replaced by nitrogen or phosphorus. Preference is given to using C₅-ring systems which do not have a carbon atom replaced by a heteroatom. It is possible, for example, for a heteroaromatic containing at least one atom from the group consisting of N, P, O and S or an aromatic to be fused to this cyclopentadienyl skeleton. In this context, “fused to” means that the heterocycle and the cyclopentadienyl skeleton share two atoms, preferably carbon atoms. The cyclopentadienyl system is bound to M^{II}.

The uncharged donor Y^{II} is an uncharged functional group containing an element of group 15 or 16 of the Periodic Table or a carbene, e.g. amine, imine, carboxamide, carboxylic ester, ketone (oxo), ether, thioketone, phosphene, phosphite, phosphine oxide, sulfonyl, sulfonamide, carbenes such as N-substituted imidazol-2-ylidene or unsubstituted, substituted or fused, partially unsaturated heterocyclic or heteroaromatic ring systems. The donor Y^{II} can be bound intermolecularly or intramolecularly to the transition metal M^{II} or not be bound to it. Preference is given to the donor Y^{II} being bound intramolecularly to the metal center M^{II}.

M^{II} is a metal selected from the group consisting of titanium, zirconium, hafnium, vanadium, niobium, tantalum, chromium, molybdenum and tungsten. The oxidation states of the transition metals M^{II} in catalytically active complexes are usually known to those skilled in the art. Chromium, molybdenum and tungsten are very probably present in the oxidation state +3, titanium, zirconium, hafnium and vanadium in the oxidation state 4, with titanium and vanadium also being able to be present in the oxidation state 3. However, it is also possible to use complexes whose oxidation state does not correspond to that of the active catalyst. Such complexes can then be appropriately reduced or oxidized by means of suitable activators. M^{II} is preferably titanium, vanadium, chromium, molybdenum or tungsten. Particular preference is given to chromium in the oxidation states 2, 3 and 4, in particular 3.

m can be 1, 2 or 3, i.e. 1, 2 or 3 donor groups Y^{II} can be bound to Cp^{II}. If 2 or 3 Y^{II} groups are present, these can be identical or different. Preference is given to only one donor group Y^{II} being bound to Cp^{II} (m=1).

Further ligands can consequently be bound to the metal atom M^{II}. The number of further ligands depends, for example, on the oxidation state of the metal atom. The ligands are not further cyclopentadienyl systems. Suitable ligands are monoanionic and dianionic ligands as described by way of example for X^{II}. In addition, Lewis bases such as amines, ethers, ketones, aldehydes, esters, sulfides or phosphines may be bound to the metal center M^{II}. The monocyclopentadienyl complexes can be in monomeric, dimeric or oligomeric form. The monocyclopentadienyl complexes are preferably in monomeric form.

Particularly useful monocyclopentadienyl complexes are ones in which Y^{II} is formed by the group —Z^{II}ₖ-A^{II}- and together with the cyclopentadienyl system Cp^{II} and M^{II} forms a monocyclopentadienyl complex comprising the structural element of the formula Cp^{II}-Z^{II}ₖ-A M^{II}X^{II}ₙ (IIA).

The group Cp^{II}-Z^{II}ₖ-A^{II} is represented by formula (IIB)

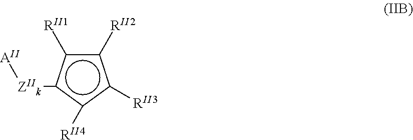

where the variables have the following meanings:
R^{II1}-R^{II4} are each, independently of one another, hydrogen, C₁-C₂₂-alkyl, C₂-C₂₂-alkenyl, C₆-C₂₂-aryl, alkylaryl having from 1 to 10 carbon atoms in the alkyl radical and 6-20 carbon atoms in the aryl radical, NR^{II5}₂, N(SiR^{II5}₃)₂, OR^{II5}, OSiR^{II5}₃, SiR^{II5}₂, BR^{II5}₂, where the organic radicals R^{II1}-R^{II4} may also be substituted by halogens and two vicinal radicals R^{II1}-R^{II4} may also be joined to form a five-, six- or seven-membered ring, and/or two vicinal radicals R^{II1}-R^{II4} are joined to form a five-, six- or seven-membered heterocycle which contains at least one atom from the group consisting of N, P, O or S,
R^{II5} the radicals R^{II5} are each, independently of one another, hydrogen, C₁-C₂₀-alkyl, C₂-C₂₀-alkenyl, C₆-C₂₀-aryl, alkylaryl having from 1 to 10 carbon atoms in the alkyl part and 6-20 carbon atoms in the aryl part and two geminal radicals R^{II5} may also be joined to form a five- or six-membered ring, where the organic radicals R^{II1}-R^{II5} may also be substituted by halogens,
Z^{II} is a divalent bridge between A^{II} and Cp^{II} selected from the group consisting of —C(R^{II6}R^{II7})—, —Si(R^{II6}R^{II7})—, —C(R^{II6}R^{II7})C(R^{II8}R^{II9})—, —Si(R^{II6}R^{II7})Si(R^{II8}R^{II9})—
R^{II6}-R^{II9} are each, independently of one another, hydrogen, C₁-C₂₀-alkyl, C₂-C₂₀-alkenyl, C₆-C₂₀-aryl, alkylaryl having from 1 to 10 carbon atoms in the alkyl part and 6-20 carbon atoms in the aryl part or SiR^{II10}₃, two geminal or vicinal radicals R^{II6}-R^{II9} may also be joined to form a five- or six-membered ring and
R^{II10} are each, independently of one another, hydrogen, C₁-C₂₀-alkyl, C₂-C₂₀-alkenyl, C₆-C₂₀-aryl, alkylaryl having from 1 to 10 carbon atoms in the alkyl part and 6-20 carbon atoms in the aryl part and two geminal radicals R^{II10} may also be joined to form a five- or six-membered ring, where the organic radicals R^{II6}-R^{II10} may also be substituted by halogens,
A^{II} is an uncharged donor group containing one or more atoms of group 15 and/or 16 of the Periodic Table of the Elements or a carbene, preferably an unsubstituted, substituted or fused, heteroaromatic ring system,
M^{II} is a metal selected from the group consisting of chromium, molybdenum and tungsten and
k is 0 or 1.

Particularly preferred substituents R^{II1} to R^{II4} are hydrogen, C₁-C₄-alkyl which may be linear or branched, e.g. methyl, ethyl, n-propyl, isopropyl, n-butyl, isobutyl, tert-butyl, C₆-C₁₂-aryl which may be substituted by further alkyl groups, e.g. phenyl, naphthyl, biphenyl, anthranyl, o-, m-, p-methylphenyl, 2,3-, 2,4-, 2,5-, or 2,6-dimethylphen-1-yl, 2,3,4-, 2,3,5-, 2,3,6-, 2,4,5-, 2,4,6- or 3,4,5-trimethylphen-1-yl, or arylalkyl which may be substituted by further alkyl groups, e.g. benzyl, o-, m-, p-methylbenzyl, 1- or 2-ethylphenyl, or SiR^{II5}₃, wherein R^{II5} is defined as R^{II1} to R^{II4}, or two radicals R^{II1} to R^{II4} may also be joined to form a 5- or 6-membered aliphatic or aromatic ring fused to the cyclopentadienyl ring, thus forming a e.g. tetrahydroindenyl or indenyl system. The organic radicals R^{II1} to R^{II5} may also be substituted by halogens such as fluorine, chlorine or bromine, in particular fluorine, for example pentafluorophenyl or bis-3,5-trifluoromethylphen-1-yl, and alkyl or aryl.

Preferred examples of such cyclopentadienyl systems (without the group —Z-A-, which is preferably located in the 1 position) are 2,3,4-trimethyl 5-trimethylsilyl cyclopentadienyl, 2,3,4-trimethyl (3,5-di trifluoromethyl phenyl) dimethylsilyl cyclopentadienyl, pentafluorophenyl dimethylsilyl cyclopentadienyl, 2,3,4-trimethyl[5-(3,3,3 trifluoropropyl)dimethylsilyl]cyclopentadienyl, 2,3,4-trimethyl[5-propen-1-yl dimethylsilyl]cyclopentadienyl.

Z is preferably a —CR^{II6}R^{II7}— group. Especially preferred is —CH₂—.

A is an uncharged donor containing an atom of group 15 or 16 of the Periodic Table, preferably one or more atoms selected from the group consisting of oxygen, sulfur, nitrogen and phosphorus, preferably nitrogen. The donor function in A can be bound intermolecularly or intramolecularly to the metal M^{II}. The donor in A is preferably bound intramolecularly to M^{II}. Possible donors are uncharged functional groups containing an element of group 15 or 16 of the Periodic Table, e.g. amine, imine, carboxamide, carboxylic ester, ketone (oxo), ether, thioketone, phosphine, phosphite, phosphine oxide, sulfonyl, sulfonamide, carbenes such as N-substituted imidazol-2-ylidene or unsubstituted, substituted or fused, heterocyclic ring systems. The synthesis of the bond from A to the cyclopentadienyl radical and Z can be carried out, for example, by a method analogous to that of WO 00/35928. A is preferably an unsubstituted, substituted or fused heteroaromatic ring system which may comprise, apart from carbon ring atoms, heteroatoms from the group consisting of oxygen, sulfur, nitrogen and phosphorus, preferably nitrogen.

Among these heteroaromatic systems A^{II}, particular preference is given to unsubstituted, substituted and/or fused six-membered heteroaromatics having 1, 2, 3, 4 or 5 nitrogen atoms in the heteroaromatic part, in particular substituted and unsubstituted 2-pyridyl, 2-quinolyl or 8-quinolyl.

A is therefore preferably a group of the formula (IIC) or (IID)

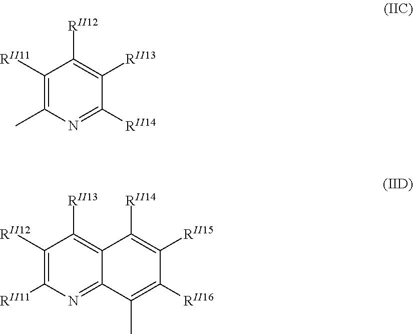

where
R^{II11}-R^{II16} are each, independently of one another, hydrogen, C₁-C₂₀-alkyl, C₂-C₂₀-alkenyl, C₆-C₂₀-aryl, alkylaryl having from 1 to 10 carbon atoms in the alkyl part and 6-20 carbon atoms in the aryl part or SiR^{II7}₃, where the organic radicals R^{II11}-R^{II16} may also be substituted by halogens or nitrogen and further C₁-C₂₀-alkyl, C₂-C₂₀-alkenyl, C₆-C₂₀-aryl, alkylaryl having from 1 to 10 carbon atoms in the alkyl part and 6-20 carbon atoms in the aryl part or SiR^{II17}₃ groups and
R^{II17} are each, independently of one another, hydrogen, C₁-C₂₀-alkyl, C₂-C₂₀-alkenyl, C₆-C₂₀-aryl or alkylaryl having from 1 to 10 carbon atoms in the alkyl part and 6-20 carbon atoms in the aryl part and two radicals R^{II16} may also be joined to form a five- or six-membered ring.

A is particularly preferably 2-pyridyl, 6-methyl-2-pyridyl, 4-methyl-2-pyridyl, 5-methyl-2-pyridyl, 5-ethyl-2-pyridyl, 4,6-dimethyl-2-pyridyl, 3-pyridazyl, 4-pyrimidyl, 6-methyl-4-pyrimidyl, 2-pyrazinyl, 6-methyl-2-pyrazinyl, 5-methyl-2-pyrazinyl, 3-methyl-2-pyrazinyl, 3-ethylpyrazinyl, 3,5,6-trimethyl-2-pyrazinyl, 2-quinolyl, 4-methyl-2-quinolyl, 6-methyl-2-quinolyl, 7-methyl-2-quinolyl, 2-quinoxalyl or 3-methyl-2-quinoxalyl.

Particular preferred is the combination of k=1, Z=—CH₂— and A=2-pyridyl or k=0 and A=8-quinolyl.

Particular preference is given to M^{II} being chromium in the oxidation states 2, 3 and 4, in particular 3.

The ligands X^{II} result from, for example, the choice of the metal compounds used as starting materials for the synthesis of the monocyclopentadienyl complexes, but can also be varied subsequently. Possible ligands X^{II} are, in particular, the halogens such as fluorine, chlorine, bromine or iodine, in particular chlorine. Alkyl radicals such as methyl, ethyl, propyl, butyl, vinyl, allyl, phenyl or benzyl are also advantageous ligands X^{II}. As further ligands X^{II}, mention may be made, purely by way of example and in no way exhaustively, of trifluoroacetate, BF₄⁻, PF₆⁻ and weakly coordinating or noncoordinating anions (cf., for example, S. Strauss in Chem. Rev. 1993, 93, 927-942) such as B(C₆F₅)₄⁻.

The number n of the ligands X^{II} depends on the oxidation state of the transition metal M^{II}. The number n can therefore not be given in general terms. The oxidation state of the transition metals M^{II} in catalytically active complexes is usually known to those skilled in the art. Chromium, molybdenum and tungsten are very probably present in the oxidation state +3, vanadium in the oxidation state +3 or +4. However, it is also possible to use complexes whose oxidation state does not correspond to that of the active catalyst. Such complexes can then be appropriately reduced or oxidized by means of suitable activators. Preference is given to using chromium complexes in the oxidation state +3.

Preferably X^{II} are each independently from one another, selected from fluorine, chlorine, bromine, iodine, C₁-C₁₀-alkyl, C₂-C₁₀-alkenyl, C₆-C₂₀-aryl, alkylaryl having 1-10 carbon atoms in the alkyl part and 6-20 carbon atoms in the aryl part, —NR¹⁸R¹⁹, —OR¹⁸, —SR¹⁸, —SO₃R¹⁸, —OC(O)R¹⁸, BF⁴⁻, PF⁶⁻ or a bulky noncoordinating anion, and R^{II18} and R^{II19} are each, independently of one another, C₁-C₂₀-alkyl, C₂-C₂₀-alkenyl, C₆-C₂₀-aryl, alkylaryl having from 1 to 10 carbon atoms in the alkyl part and 6-20 carbon atoms in the aryl part, where the organic radicals R^{II8} and R^{II19} may also be substituted by halogens and two geminal radicals R^{II18} and R^{II19} may also be joined to form a five- or six-membered ring and n is 1, 2 or 3. Preferred monocyclopentadienyl complexes of formula (II) are 1-(8-quinolyl)-3-phenylcyclopentadienylchromium(III)dichloride, 1-(8-quinolyl)-3-(1-naphthyl)cyclopentadienylchromium(III)dichloride, 1-(8-quinolyl)-3-(4-trifluoromethylphenylcyclopentadienylchromium(III)dichloride, 1-(8-quinolyl)-3-(4-chlorophenyl)cyclopentadienylchromium(III)dichloride, 1-(8-quinolyl)-2-methyl-3-phenylcyclopentadienylchromium(III)dichloride, 1-(8-quinolyl)-2-methyl-3-(1-naphthyl)cyclopentadienylchromium(III)dichloride, 1-(8-quinolyl)-2-methyl-3-(4-trifluoromethylphenylcyclopentadienylchromium(III)dichloride, 1-(8-quinolyl)-2-methyl-3-(4-chlorophenyl)cyclopentadienylchromium(III)dichloride, 1-(8-quinolyl)-2-phenylindenyl-chromium(III)dichloride, 1-(8-quinolyl)-2-phenylbenzindenylchromium(III)dichloride, 1-(8-(2-methyl-quinolyl))-2-methyl-3-phenylcyclopentadienylchromium(III)dichloride, 1-(8-(2-methylquinolyl))-2-phenyl-indenylchromium(III)dichloride, 1-(2-pyridylmethyl)-3-phenylcyclopentadienylchromium(III)dichloride, 1-(2-pyridylmethyl)-2-methyl-3-phenylcyclopentadienylchromium(III)dichloride, 1-(2-quinolylmethyl)-3-phenylcyclopentadienylchromium dichloride, 1-(2-pyridylethyl))-3-phenylcyclopentadienylchromium dichloride, 1-(2-pyridyl-1-methylethyl)-3-phenylcyclopentadienylchromium dichloride or 1-(2-pyridyl-1-phenylmethyl)-3-phenylcyclopentadienylchromium dichloride.

The synthesis of such complexes can be carried out by methods known per se, with preference being given to reacting the appropriately substituted cyclopentadienyl anions with halides of titanium, vanadium or chromium. Examples of such preparative methods are described, inter alia, in the Journal of Organometallic Chemistry, 369 (1989), 359-370, and in EP-A-1212333.

Some of the organic transition metal complexes mentioned have little polymerization activity on their own and are therefore brought into contact with an activating compound in order to be able to display good polymerization activity. For this reason, the catalyst system preferably comprises, as further component, one or more activating compounds, hereinafter also referred to as activators or cocatalysts. Depending on the type of catalyst components, one or more activators are advantageous here. For example, the same activator or activator mixture or different cocatalysts can be used for activation. It is advantageous to use the same activator for at least two, particularly advantageously all, catalyst components.

Suitable activators are, for example, compounds such as an aluminoxane, a strong uncharged Lewis acid, an ionic compound having a Lewis-acid cation or an ionic compound having a Brönsted acid as cation. Suitable activators for the types of catalyst mentioned are generally known.

The amount of the activating compounds to be used depends on the type of activator. In general, the molar ratio of active catalyst component, i.e. the monocyclopentadienyl transition metal complex to activating compound, i.e. cocatalyst can be from 1:0.1 to 1:10 000, preferably from 1:1 to 1:2000.

Preference is given to using at least one aluminoxane as activating compound for carrying out the process of the invention. It is possible to use, for example, the compounds described in WO 00/31090 as aluminoxanes. Polymethylaluminoxane (PMAO) and methylaluminoxane (MAO) are particularly useful aluminoxanes.

It has proven to be preferable if compounds of the general formula I are used as solution. Suitable solvents are, for example, aromatic hydrocarbons, such as benzene, toluene, ethylbenzene or mixtures thereof, and aliphatic hydrocarbons, such as pentane, heptane or mixtures thereof. However, it is also possible to use the compounds of general formula I in solid form, e.g. as a powder.

Compounds of the general formula I may be added in any desired order, for example in such a way that the catalyst system is prepared first and then mixed with the borane compound of the general formula I, or the activating compound is mixed with the compound of the general formula I first and the monocyclopentadiene transition metal complex subsequently. Other orders of combination are also possible. It is, however, preferred to activate the monocyclopentadiene transition metal complex in a first step, then add the borane compound of formula I and then add the combined mixture or solution to the monomer.

It is also possible initially to take the monomer and the catalyst system and then to add the compound of the general formula I, but the timespan must be chosen so that the catalyst system cannot fully display its activity. This timespan depends on the type of catalyst system and may be up to 5 minutes, preferably up to 1 minute.

The process of the invention is suitable for the polymerization of olefins and especially for the polymerization of 1-olefins, i.e. hydrocarbons having terminal double bonds, also referred to as α-olefins. Suitable monomers include functionalized olefinically unsaturated compounds such as ester or amide derivatives of acrylic or methacrylic acid, for example acrylates, methacrylates, or acrylonitrile. The process of the invention can particularly be used for the polymerization or copolymerization of ethylene. As comonomers in the polymerization of ethylene, preference is given to using C₃-C₈-1-olefins, in particular 1-butene, 1-pentene, 1-hexene and/or 1-octene.

The process of the invention for the polymerization of olefins can be carried out using all industrially known polymerization processes at temperatures in the range from 0 to 200° C., preferably from 25 to 150° C. and particularly preferably from 40 to 130° C., under pressures of from 0.05 to 10 MPa and particularly preferably from 0.3 to 4 MPa. The polymerization can be carried out batchwise or continuously in one or more stages. Solution processes, suspension processes, stirred gas-phase processes and gas-phase fluidized-bed processes are all possible. Processes of this type are generally known to those skilled in the art.

In a preferred embodiment of the preparation of the catalyst system, the active catalyst component is brought into contact with an activator in solution first and subsequently added to a solution of the modifier. However, it is also possible to prepare a solution of activator and modifier first and subsequently add the active catalyst component.

The following examples and figures merely illustrate the invention. Those skilled in the art will recognize many variations that are within the spirit of the invention and scope of the claims.

In the examples the following complexes are used as active catalyst components. In the tables reference is made to the respective complex number.

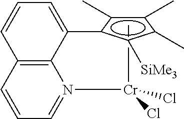

### Complex 1: 1-(8-quinolyl)2,3,4-trimethyl 5-trimethylsilyl cyclopentadienyl chromium dichloride

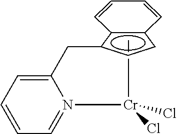

### Complex 2: 1-(2-methylenepyridyl)indenyl chromium dichloride

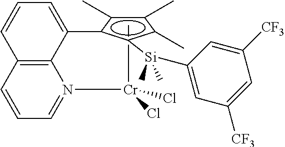

### Complex 3: 1-(8-quinolyl)2,3,4-trimethyl(3,5-di trifluoromethyl phenyl)dimethylsilyl cyclopentadienylchromium dichloride

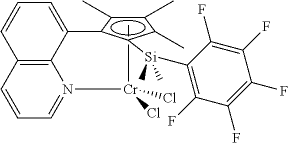

### Complex 4: 1-(8-quinolyl)pentafluorophenyl dimethylsilyl cyclopentadienylchromium dichloride

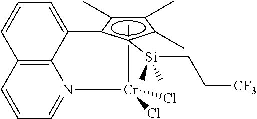

### Complex 5: 1-(8-quinolyl)2,3,4-trimethyl[5-(3,3,3 trifluoropropyl)dimethylsilyl]cyclopentadienyl chromium dichloride

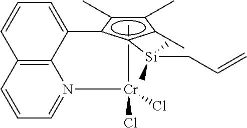

### Complex 6: 1-(8-quinolyl)2,3,4-trimethyl[5-propen-1-yl dimethylsilyl]cyclopentadienyl chromium dichloride

Molecular weight and molecular-weight distributions of the polymers were determined at 150° C. by means of gel permeation chromatography on a PL-GPC220 (Varian) equipped with refractive-index detector and three separating columns (“Olexis”, 300 mm×8 mm, Polymer Laboratories) with 1,2,4-trichlorobenzene as solvent. The molecular weight of PE was referenced to polystyrene standards purchased from Polymer Laboratories. DSC measurements were determined with a DSC821^{e} unit from METTLER-Toledo, applying a heating rate of 10 K/min.

### COMPARATIVE EXAMPLES C1, C3, C5, C7, C9, C11, C14

The appropriate amount of cocatalyst (7% PMAO in toluene) was added to a solution of the respective complex as indicated in Table 1 in 120 ml of toluene. Ethylene was passed through the solution at atmospheric pressure while stirring. After a period indicated in Table 1 the reaction mixture was cooled by a water bath. Cloudiness of the solution and rise of viscosity was monitored, showing progress of polymerization. The polymerization was stopped by addition of methanolic HCl solution, the polymer was filtered off, stirred in acetone for 2 h, again filtered off and dried at 80° C. over night. Details and results are shown in Table 1.

### EXAMPLE 2

### Polymerization of Complex 2

PMAO-solution (4.68 g, 7% PMAO in toluene) was added to 0.004 g (0.012 mmol) of Complex 2. The resulting violet solution was added to a solution of 0.29 g (2.38 mmol) 9-BBN in 120 ml toluene. Ethylene was passed through the solution at atmospheric pressure over a period indicated in Table 1 while stirring. The reaction mixture was cooled by a water bath. Cloudiness of the solution and rise of viscosity was monitored. The polymerization was stopped by addition of methanolic HCl solution, the polymer was filtered off, stirred in acetone for 2 h, again filtered off and dried at 80° C. over night. Details and results are shown in Table 1.

### EXAMPLE 4

### Polymerization of Complex 1

PMAO-solution (3.59 g, 7% PMAO in toluene) was added to a solution of 0.004 g (0.0093 mmol) of Complex 1 in 10 ml of toluene. The resulting violet solution was added to a solution of 0.227 g (1.86 mmol) 9-BBN in 120 ml toluene. Ethylene was passed through the solution at atmospheric pressure over a period indicated in Table 1 while stirring. Cloudiness of the solution and rise of viscosity was monitored. The reaction mixture was cooled by a water bath. The polymerization was stopped by addition of methanolic HCl solution, the polymer was filtered off, stirred in acetone for 2 h, again filtered off and dried at 80° C. over night. The results are shown in Table 1.

### EXAMPLE 6

### Polymerization of Complex 3

This example was performed according to the same procedure as described in example 4 with the exception that 2.46 g PMAO-solution was added to a solution of 0.004 g (6.37·10⁻³ mmol) of Complex 3 in 10 ml of toluene and the resulting violet solution was added to a solution of 0.155 g (1.274 mmol) 9-BBN in 120 ml toluene. Details and results are shown in Table 1.

### EXAMPLE 8

### Polymerization of Complex 5

This example was performed according to the same procedure as described in example 4 with the exception that 3.01 g PMAO-solution was added to a solution of 0.004 g (7.82·10⁻³ mmol) of Complex 5 in ml of toluene and the resulting violet solution was added to a solution of 0.19 g (1.564 mmol) 9-BBN in 120 ml toluene. Details and results are shown in Table 1.

### EXAMPLE 10

### Polymerization of Complex 4

This example was performed according to the same procedure as described in example 4 with the exception that 2.650 g PMAO-solution was added to a solution of 0.004 g (6.88·10⁻³ mmol) of Complex 4 in 10 ml of toluene and the resulting violet solution was added to a solution of 0.168 g (1.376 mmol) 9-BBN in 120 ml toluene. Details and results are shown in Table 1.

### COMPARATIVE EXAMPLE C12

### Polymerization of Biscyclopentadienyl Zirconium Dichloride

PMAO-solution (3.95 g, 7% PMAO in toluene) was added to a solution of 0.003 g (0.010 mmol) of biscyclopentadienyl zirconium dichloride in 10 ml of toluene. The resulting colorless solution was added to a solution of 0.25 g (2.05 mmol) 9-BBN in 120 ml toluene. Ethylene was passed through the solution at atmospheric pressure over a period indicated in Table 1 while stirring. The reaction mixture was cooled by a water bath. Cloudiness of the solution and rise of viscosity was monitored. The polymerization was stopped by addition of methanolic HCl solution, the polymer was filtered off, stirred in acetone for 2 h, again filtered off and dried at 80° C. over night. The results are shown in Table 1.

### EXAMPLE 13

### Polymerization of Complex 1

PMAO-solution (3.59 g, 7% PMAO in toluene) was added to 0.227 g (1.86 mmol) 9-BBN and stirred over night. A solution of 0.004 g (0.00931 mmol) of Complex 1 in 10 ml of toluene was subsequently added and the resulting mixture was added to 120 ml toluene. Ethylene was passed through the solution at atmospheric pressure over a period indicated in Table 1 while stirring. The reaction mixture was cooled by a water bath. Weak cloudiness of the solution was monitored. The polymerization was stopped by addition of methanolic HCl solution, the polymer was filtered off, stirred in acetone for 2 h, again filtered off and dried at 80° C. over night. The results are shown in Table 1.

### EXAMPLE 15

### Polymerization of Complex 6

This example was performed according to the same procedure as described in example 4 with the exception that 3.21 g PMAO-solution was added to a solution of 3.8 mg g (8.34·10⁻³ mmol) of Complex 6 in 10 ml of toluene and the resulting brown-orange solution was added to a solution of 0.204 g (1.67 mmol) 9-BBN in 120 ml toluene. Details and results are shown in Table 1.

| | | | | | | | | Poly- | | |
|---|---|---|---|---|---|---|---|---|---|---|
| | Catalyst | c_{cat} | Co- | | | | Polym.- | ethylene | Activity | M_{w} |
| Example | Complex | [μmol] | catalyst | Cocatalyst:Cr | Modifier | Modifier:Cr | time | [g] | [g mmol⁻¹ h⁻¹] | [10⁴ g/mol] |
| C1 | 2 | 12.10 | PMAO | 1000:1 | — | | 25 | 4.76 | 952 | 4.01 |
| 2 | 2 | 12.00 | PMAO | 1000:1 | 9-BBN | 200:1 | 17 | 5.35 | 1573 | 10.16 |
| C3 | 1 | 9.31 | PMAO | 1000:1 | — | | 23 | 4.95 | 1395 | 1.44 |
| 4 | 1 | 9.31 | PMAO | 1000:1 | 9-BBN | 200:1 | 11 | 3.51 | 2055 | 20.91 |
| C5 | 3 | 6.37 | PMAO | 1000:1 | — | | 20 | 3.37 | 1586 | 0.89 |
| 6 | 3 | 6.37 | PMAO | 1000:1 | 9-BBN | 200:1 | 15 | 3.60 | 2259 | 21.45 |
| C7 | 5 | 7.82 | PMAO | 1000:1 | — | | 18 | 4.48 | 1909 | 6.12 |
| 8 | 5 | 7.82 | PMAO | 1000:1 | 9-BBN | 200:1 | 14 | 3.76 | 2060 | 27.78 |
| C9 | 4 | 6.88 | PMAO | 1000:1 | — | | 14 | 2.32 | 1445 | 6.59 |
| 10 | 4 | 6.88 | PMAO | 1000:1 | 9-BBN | 200:1 | 18 | 1.26 | 610 | 28.80 |
| C11 | Cp₂ZrCl₂ | 10.30 | PMAO | 1000:1 | — | | 12 | 4.78 | 2332 | 6.00 |
| C12 | Cp₂ZrCl₂ | 10.30 | PMAO | 1000:1 | 9-BBN | 200:1 | 17 | 3.43 | 1181 | 4.30 |
| 13 | 1 | 9.31 | PMAO | 1000:1 | 9-BBN | 200:1 | 13 | 0.38 | 187 | 22.00 |
| C14 | 6 | 7.68 | PMAO | 1000:1 | — | | 14 | 4.99 | 2780 | 10.65 |
| 15 | 6 | 8.34 | PMAO | 1000:1 | 9-BBN | 200:1 | 14 | 3.87 | 1989 | 19.15 |

### EXAMPLE 17

The polymerization tests were carried out employing an ASW2000 Chemspeed® unit using 35 ml of a 20 μmol/1-solution of Complex 1 in toluene, 250 equivalents of MAO (10% solution in toluene) and 0.1 bar over pressure, while the temperature was maintained at 40° C. during polymerization process (60 min).

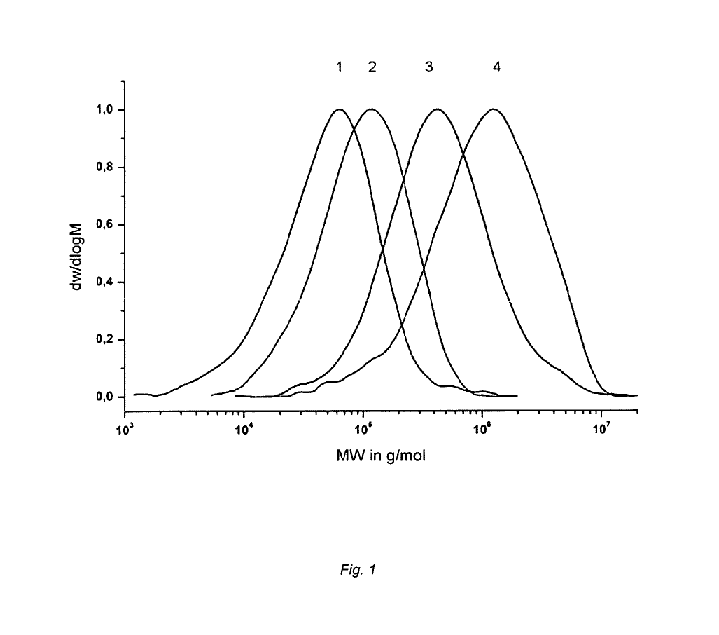

TABLE 2

| Graph | | | | | | Poly- | Activity | | |
|---|---|---|---|---|---|---|---|---|---|
| in | c_{cat} | | | | Polym.- | ethylene | [g mmol⁻¹ | M_{w} | |
| FIG. 1 | [μmol] | Cocat:Cr | Modifier | Modifier:Cr | time | [g] | h⁻¹] | [10⁴ g/mol] | PDI |
| 1 | 0.70 | 250:1 | — | — | 12 | 2.87 | 3243 | 0.74 | 2.40 |
| 2 | 0.70 | 250:1 | 9-BBN | 50:1 | 20 | 4.27 | 2200 | 1.36 | 2.00 |
| 3 | 0.70 | 250:1 | 9-BBN | 150:1 | 20 | 5.89 | 3298 | 6.73 | 2.60 |
| 4 | 0.70 | 250:1 | 9-BBN | 200:1 | 15 | 3.98 | 2972 | 16.07 | 2.40 |

The results are shown in FIG. 1. The FIGURE clearly shows the increase of molecular weight Mw with increase of amount of 9-BBN added.

1. A catalyst system comprising a monocyclopentadiene transition metal complex and
a compound of the formula I: 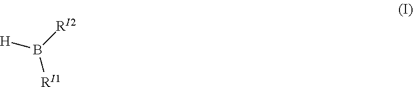
wherein
R^{I1}, R^{I2} are each independently from one another C₁-C₂₀-alkyl, C₆-C₄₀-aryl, alkylaryl or arylalkyl, each having 1 to 10 carbon atoms in the alkyl radical and 6 to 20 carbon atoms in the aryl radical, or 5- to 7-membered C₁-C₂₀-cycloalkyl which optionally may comprise C₁-C₁₀-alkyl as a substituent, or R^{I1} and R^{I2} together form a cyclic group of 4 to 15 carbon atoms.

2. The catalyst system according to claim 1, wherein R^{I1} and R^{I2} in formula I together form a bicyclic group of 4 to 15 carbon atoms.

3. The catalyst system according to claim 1, wherein the monocyclopentadiene transition metal complex is a compound of formula II:
Cp^{II}-Y^{II}ₘM^{II} (II),
where the variables have the following meanings:
Cp^{II} is a cyclopentadienyl system,
Y^{II} is a substituent which is bound to Cp^{II} and contains at least one uncharged donor containing at least one atom of group 15 or 16 of the Periodic Table,
M^{II} is titanium, zirconium, hafnium, vanadium, niobium, tantalum, chromium, molybdenum or tungsten or an element of group 3 of the Periodic Table and the lanthanides, and
m is 2 or 3.

4. The catalyst system according to claim 3, where the monocyclopentadiene transition metal complex is a compound of formula (IIA):
Cp^{II}-Y^{II}ₘM^{II}X^{II}ₙ (IIA),
and
Cp^{II} and Y^{II} together form a compound of formula (IIB): 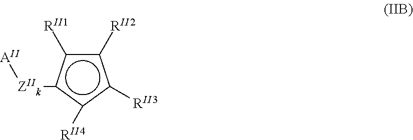
where the variables have the following meanings:
R^{II1}-R^{II4} are each, independently of one another, hydrogen, C₁-C₂₀-alkyl, C₂-C₂₀-alkenyl, C₆-C₂₀-aryl, alkylaryl having from 1 to 10 carbon atoms in the alkyl part and 6-20 carbon atoms in the aryl part or SiR^{II5}₃, where the organic radicals R^{II1}-R^{II5} may optionally be substituted by halogens, and two geminal or vicinal radicals R^{II6}-R^{II4} may optionally be joined to form a five- or six-membered ring,
Z^{II} is a divalent bridge between A^{II} and Cp^{II} selected from the group consisting of —C(R^{II6}R^{II7})—, —Si(R^{II6}R^{II7})—, and —C(R^{II6}R^{II7})C(R^{II8}R^{II9})—,
R^{II6}-R^{II9} are each, independently of one another, hydrogen, C₁-C₂₀-alkyl, C₂-C₂₀-alkenyl, C₆-C₂₀-aryl, alkylaryl having from 1 to 10 carbon atoms in the alkyl part and 6-carbon atoms in the aryl part or SiR^{II10}₃, where the organic radicals R^{II6}-R^{II10} may optionally be substituted by halogens and two geminal or vicinal radicals R^{II6}-R^{II9} may optionally be joined to form a five- or six-membered ring,
A^{II} is a group of the formula (IIB) or (IIC): 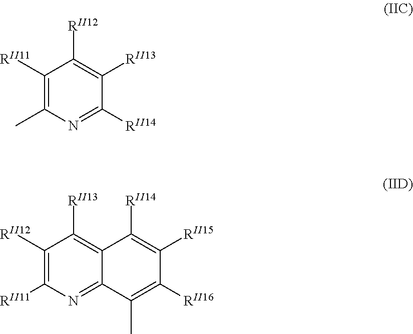
where
R^{II11}-R^{II16} are each, independently of one another, hydrogen, C₁-C₂₀-alkyl, C₂-C₂₀-alkenyl, C₆-C₂₀-aryl, alkylaryl having from 1 to 10 carbon atoms in the alkyl part and 6-20 carbon atoms in the aryl part or SiR^{II16}₃, where the organic radicals R^{II11}-R^{II16} may optionally be substituted by halogens or nitrogen and further C₁-C₂₀-alkyl, C₂-C₂₀-alkenyl, C₆-C₂₀-aryl, alkylaryl having from 1 to 10 carbon atoms in the alkyl part and 6-carbon atoms in the aryl part or SiR^{II17}₃ groups,
R^{II17} are each, independently of one another, hydrogen, C₁-C₂₀-alkyl, C₂-C₂₀-alkenyl, C₆-C₂₀-aryl or alkylaryl having from 1 to 10 carbon atoms in the alkyl part and 6-20 carbon atoms in the aryl part and two radicals R^{II16} may optionally be joined to form a five- or six-membered ring,
M^{II} is a metal selected from chromium, molybdenum and tungsten,
k is 0 or 1,
X^{II} are each independently from one another, fluorine, chlorine, bromine, iodine, C₁-C₁₀-alkyl, C₂-C₁₀-alkenyl, C₆-C₂₀-aryl, alkylaryl having 1-10 carbon atoms in the alkyl part and 6-20 carbon atoms in the aryl part, —NR¹⁸R¹⁹, —OR¹⁸, —SR¹⁸, —SO₃R¹⁸, —OC(O)R¹⁸, BF⁴⁻, PF⁶⁻ or a bulky noncoordinating anion,
R^{II18} and R^{II19} are each, independently of one another, C₁-C₂₀-alkyl, C₂-C₂₀-alkenyl, C₆-C₂₀-aryl, alkylaryl having from 1 to 10 carbon atoms in the alkyl part and 6-20 carbon atoms in the aryl part, where the organic radicals R^{II8} and R^{II19} may optionally be substituted by halogens and two geminal radicals, and R^{II18} and R^{II19} may optionally be joined to form a five- or six-membered ring, and
n is 1, 2 or 3.

5. The catalyst system according to claim 3 where the catalyst system is prepared by first activating the monocyclopentadiene transition metal complex by an activating compound and subsequently adding the boron compound of formula (I).

6. A method comprising controlling the molecular weight of polymerized α-olefins to higher values by polymerizing α-olefins in the presence of a catalyst system according to claim 1.

7. A process comprising preparing polymers of α-olefins in the presence of a catalyst system comprising a monocyclopentadiene transition metal complex and a boron compound of formula I: 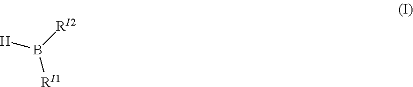
wherein
R^{I1}, R^{I2} are each C₁-C₂₀-alkyl, C₆-C₄₀-aryl, alkylaryl or arylalkyl, each having 1 to 10 carbon atoms in the alkyl radical and 6 to 20 carbon atoms in the aryl radical, or 5- to 7-membered C₁-C₂₀-cycloalkyl which in turn may carry C₁-C₁₀-alkyl as a substituent, or R^{I1} and R^{I2} together form a cyclic group of 4 to 15 carbon atoms is added.

8. The process according to claim 7, wherein R^{I1} and R^{I2} in formula I together form a bicyclic group of 4 to 15 carbon atoms.

9. The process according to claim 7, wherein the monocyclopentadiene transition metal complex is a compound of formula (II):
Cp^{II}-Y^{II}ₘM^{II} (II),
where the variables have the following meanings:
Cp^{II} is a cyclopentadienyl system,
Y^{II} is a substituent which is bound to Cp^{II} and contains at least one uncharged donor containing at least one atom of group 15 or 16 of the Periodic Table,
M^{II} is titanium, zirconium, hafnium, vanadium, niobium, tantalum, chromium, molybdenum or tungsten or an element of group 3 of the Periodic Table and the lanthanides and
m is 1, 2 or 3.

10. The process according to claim 9, where the monocyclopentadiene transition metal complex is a compound of formula (IIA):
Cp^{II}-Y^{II}ₘM^{II}X^{II}ₙ (IIA),
and
Cp^{II} and Y^{II} together form a compound of formula (IIB): 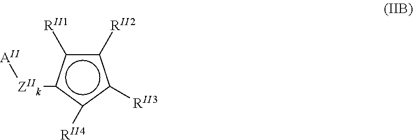
where the variables have the following meanings:
R^{II1}-R^{II4} are each, independently of one another, hydrogen, C₁-C₂₀-alkyl, C₂-C₂₀-alkenyl, C₆-C₂₀-aryl, alkylaryl having from 1 to 10 carbon atoms in the alkyl part and 6-20 carbon atoms in the aryl part or SiR^{II5}₃, where the organic radicals R^{II1}-R^{II5} may optionally be substituted by halogens and two geminal or vicinal radicals R^{II1}-R^{II4} may optionally be joined to form a five- or six-membered ring,
R^{II15} are each, independently of one another, C₁-C₂₀-alkyl, C₂-C₂₀-alkenyl, C₆-C₂₀-aryl or alkylaryl having from 1 to 10 carbon atoms in the alkyl part and 6-20 carbon atoms in the aryl part and two radicals R^{II15} may optionally be joined to form a five- or six-membered ring,
Z^{II} is a divalent bridge between A^{II} and Cp^{II} selected from the group consisting of —C(R^{II6}R^{II7})—, —Si(R^{II6}R^{II7})—, and —C(R^{II6}R^{II7})C(R^{II8}R^{II9})—,
R^{II6}-R^{II9} are each, independently of one another, hydrogen, C₁-C₂₀-alkyl, C₂-C₂₀-alkenyl, C₆-C₂₀-aryl, alkylaryl having from 1 to 10 carbon atoms in the alkyl part and 6-20 carbon atoms in the aryl part or SiR^{II10}₃, where the organic radicals R^{II6}-R^{II10} may optionally be substituted by halogens and two geminal or vicinal radicals R^{II6}-R^{II10} may optionally be joined to form a five- or six-membered ring,
A^{II} is a group of the formula (IIC) or (IID): 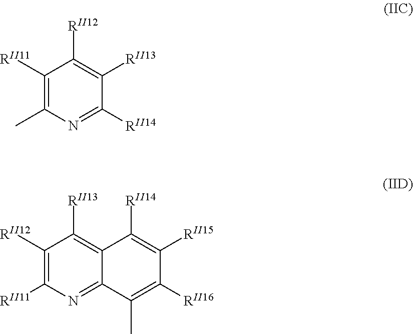
where
R^{II11}-R^{II16} are each, independently of one another, hydrogen, C₁-C₂₀-alkyl, C₂-C₂₀-alkenyl, C₆-C₂₀-aryl, alkylaryl having from 1 to 10 carbon atoms in the alkyl part and 6-20 carbon atoms in the aryl part or SiR^{II16}₃, where the organic radicals R^{II11}-R^{II16} may optionally be substituted by halogens or nitrogen and further C₁-C₂₀-alkyl, C₂-C₂₀-alkenyl, C₆-C₂₀-aryl, alkylaryl having from 1 to 10 carbon atoms in the alkyl part and 6-20 carbon atoms in the aryl part or SiR^{II17}₃ groups,
R^{II17} are each, independently of one another, C₁-C₂₀-alkyl, C₂-C₂₀-alkenyl, C₆-C₂₀-aryl or alkylaryl having from 1 to 10 carbon atoms in the alkyl part and 6-20 carbon atoms in the aryl part and two radicals R^{II16} may optionally be joined to form a five- or six-membered ring,
M^{II} is a metal selected from chromium, molybdenum and tungsten,
k is 0 or 1,
X^{II} are each independently from one another, fluorine, chlorine, bromine, iodine, C₁-C₁₀-alkyl, C₂-C₁₀-alkenyl, C₆-C₂₀-aryl, alkylaryl having 1-10 carbon atoms in the alkyl part and 6-20 carbon atoms in the aryl part, —NR¹⁸R¹⁹, —OR¹⁸, —SR¹⁸, —SO₃R¹⁸, —OC(O)R¹⁸, BF⁴⁻, PF⁶⁻ or a bulky noncoordinating anion,
R^{II18} and R^{II19} are each, independently of one another, C₁-C₂₀-alkyl, C₂-C₂₀-alkenyl, C₆-C₂₀-aryl, alkylaryl having from 1 to 10 carbon atoms in the alkyl part and 6-20 carbon atoms in the aryl part, where the organic radicals R^{II8} and R^{II19} may optionally be substituted by halogens and two geminal radicals R^{II18} and R^{II19} may optionally be joined to form a five- or six-membered ring, and
n is 1, 2 or 3.

11. The process according to claim 9 where the catalyst system is prepared by first activating the monocyclopentadiene transition metal complex by an activating compound and subsequently adding the boron compound of formula (I).
